(19) United States
(12) Patent Application Publication
(10) Pub. No.: US 2014/0164845 A1
(43) Pub. Date: Jun. 12, 2014

(54) HOST COMPUTER AND METHOD FOR TESTING SAS EXPANDERS

(71) Applicant: HON HAI PRECISION INDUSTRY CO., LTD., New Taipei (TW)

(72) Inventor: CHIH-HUANG WU, New Taipei (TW)

(73) Assignee: HON HAI PRECISION INDUSTRY CO., LTD., New Taipei (TW)

(21) Appl. No.: 14/064,201

(22) Filed: Oct. 28, 2013

(30) Foreign Application Priority Data
Dec. 12, 2012 (TW) 101146851

(51) Int. Cl. G06F 11/22

(52) U.S. Cl. CPC G06F 11/2221
USPC 714/44

(57) ABSTRACT

In a method for testing serial attached small computer system interface (SAS) expanders using a host computer, the host computer connects to a master SAS expander through a first serial port, and connects to slave SAS expanders through a second serial port. The host computer sends a test command to the master SAS expander to test the master SAS expander, and stores the test result of the master SAS expander into a flash memory of the master SAS expander. The host computer controls the master SAS expander to transfer the test command to each of the slave SAS expanders to test each of the slave SAS expanders, and stores the test result of each of the slave SAS expanders into the flash memory. The host computer displays all the test results on a display device of the host computer obtained from the flash memory.

### BACKGROUND

1. Technical Field

Embodiments of the present disclosure relate to Serial Attached Small Computer System Interface (SAS) expander systems, and particularly to a host computer and a method for testing a plurality of SAS expanders.

2. Description of Related Art

SAS expanders can be generally described as a switch device that allows initiator devices and target devices to communicate with each other, and allows additional initiator devices and target devices to be added to an SAS expander storage system. Each of the SAS expanders has a unique SAS address to communicate with each other in the SAS expander storage system. However, if one of the SAS expanders fails to function, data error may occur in the SAS expander storage system. To ensure reliability and functionality of the SAS expanders, each of the SAS expanders must be tested before being shipped from the manufacture. It is time-consuming and inefficient to manually test a large number of SAS expanders. Therefore, there is need a system and method to automatically test a plurality of SAS expanders at the same time.

### BRIEF DESCRIPTION OF THE DRAWINGS

FIG. 1 is a block diagram of one embodiment of a host computer including an SAS expander testing system.

FIG. 2 is a block diagram illustrating function modules of the SAS expander testing system included in the host computer of FIG. 1.

FIG. 3 is a flowchart of one embodiment of a method for testing SAS expanders using the host computer of FIG. 1.

FIG. 4 shows one embodiment of a flash memory for storing test results of SAS expanders.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable media or storage medium. Some non-limiting examples of a non-transitory computer-readable medium include CDs, DVDs, flash memory, and hard disk drives.

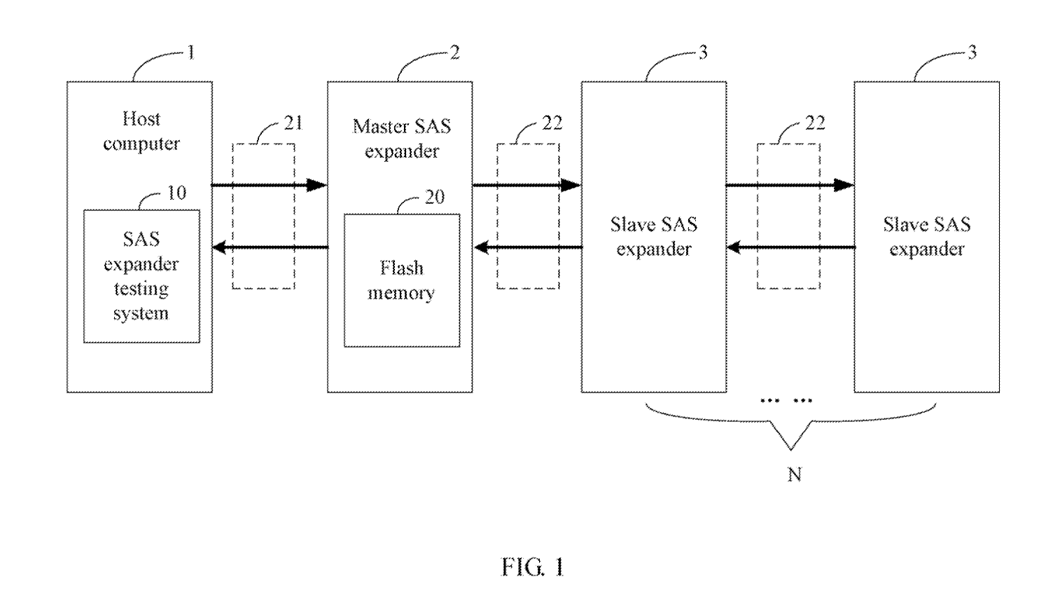

FIG. 1 is a block diagram of one embodiment of a host computer 1 including a serial attached small computer system interface (SAS) expander testing system 10. In the embodiment, the SAS expander testing system 10 is implemented by the host computer 1, and automatically tests a plurality of SAS expanders to ensure reliability and functionality of each of the SAS expanders. The host computer 1 connects to a master SAS expander 2 through a first serial port 21, and the master SAS expander 2 connects to a plurality of slave master SAS expander 3 through N numbers of second serial ports 22. Each of the slave SAS expanders 3 connects to the master SAS expander 2 in series, and can communicate with the master SAS expander 2 through the second serial ports 22. In one embodiment, the host computer 1 is a personal computer, a server computer, or a workstation computer, or other computing device. The master SAS expander 2 and each of the slave SAS expanders 3 can connect to one or more storage devices, such as hard disk drives (HDD).

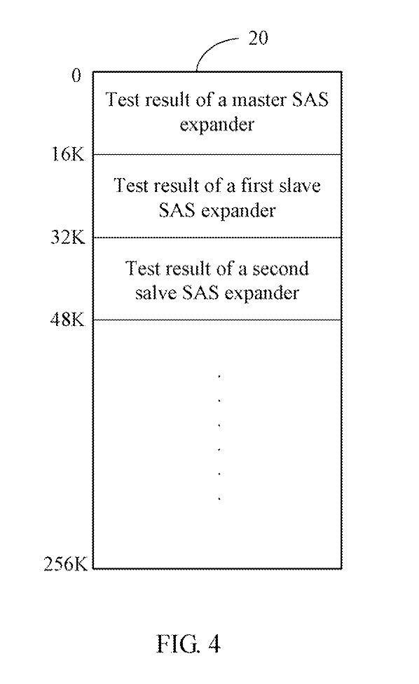

The master SAS expander 2 includes a flash memory 20 which is used to store a test result of the master SAS expander 2 and a test result of each of the slave SAS expanders 3. FIG. 4 is shows one embodiment of the flash memory 20 of the master SAS expander 2. In the embodiment, the storage capacity of the flash memory 20 is 256 Kbytes, and is divided into a plurality of data storage blocks, such as a first data storage block, a second data storage block, and a third data storage block. The first data storage block is used to store the test result of the master SAS expander 2, the second data storage block is used to store the test result of a first slave SAS expander 3, and the third data storage block is used to store the test result of a second slave SAS expander 3.

Each of the first serial port 21 and the second serial port 22 is a serial communication physical interface used in a computing device, such as a RS-232 port, which includes a data transmitting port and a data receiving port that transfers information in or out one bit at a time through the computing device. Each of the first serial port 21 and the second serial port 22 is configured with a plurality of parameters including a bit rate (e.g., 1024 bits per a second), data transfer bits (e.g., 8 bits), data control bits (e.g., 2 bits), and a data checksum.

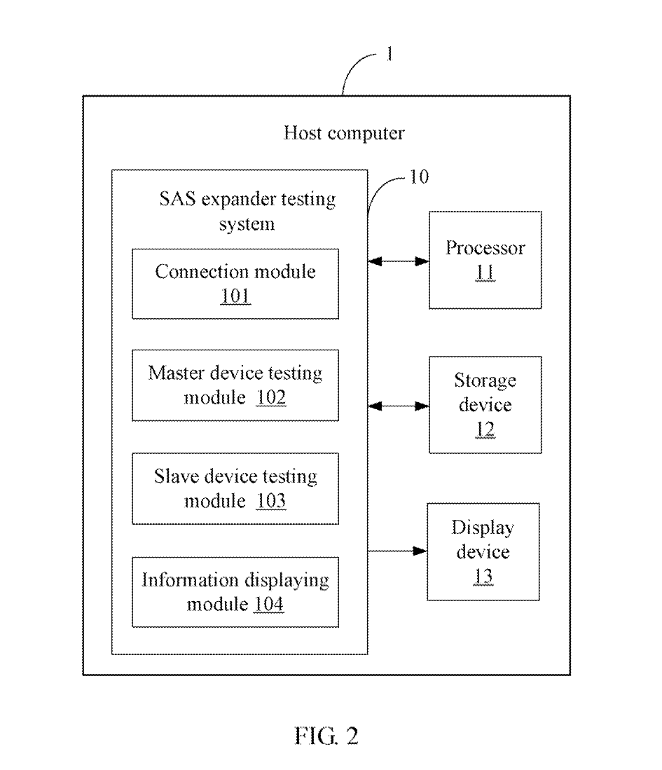

FIG. 2 is a block diagram illustrating function modules of the SAS expander testing system 10 included in the host computer 1. In the embodiment, the host computer 1 further includes, but is not limited to, at least one processor 11, a storage device 12, and a display device 13. The SAS expander testing system 10 may include computerized instructions in the form of one or more programs that are stored in the storage device 12 and executed by the at least one processor 11.

In one embodiment, the storage device 12 may be an internal storage system, such as a random access memory (RAM) for temporary storage of information, and/or a read only memory (ROM) for permanent storage of information. The storage device 12 may also be an external storage system, such as an external hard disk, a storage card, or a non-transitory storage medium. The at least one processor 12 is a central processing unit (CPU) or microprocessor that performs various functions of the host computer device 1.

In the embodiment, the SAS expander testing system 10 includes a connection module 101, a master device testing module 102, a slave device testing module 103, and an information displaying module 104. The modules 101-104 may comprise computerized instructions in the form of one or more computer-readable programs that are stored in a non-transitory computer-readable medium (such as the storage device 12) and executed by the at least one processor 11. A description of each module is given in the following paragraphs.

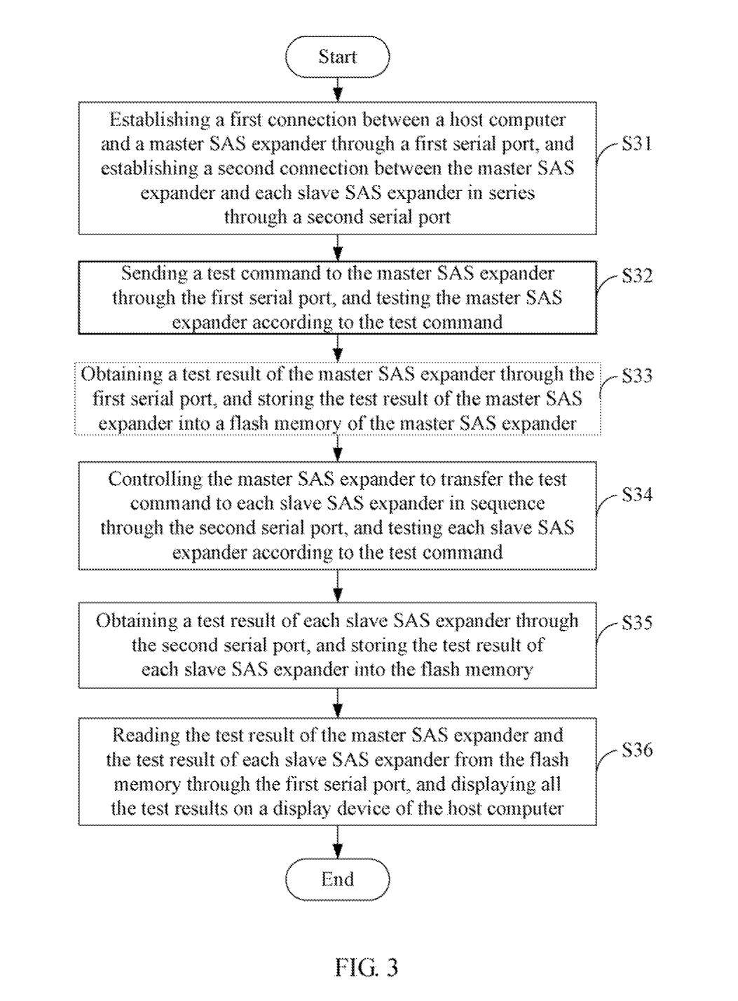

FIG. 3 is a flowchart of one embodiment of a method for testing SAS expanders using the host computer 1. In the embodiment, the method can automatically tests a plurality of SAS expanders including the master SAS expander 2 and N numbers of slave SAS expanders 3, to ensure reliability and functionality of each of the SAS expanders. Depending on the embodiment, additional steps may be added, others removed, and the ordering of the steps may be changed.

In step S31, the connection module 101 establishes a first connection between the host computer 1 and the master SAS expander 2 through the first serial port 21, and establishes a second connection between the master SAS expander 2 and each of the slave SAS expanders 3 in series through the second serial port 22.

In step S32, the master device testing module 102 sends a test command to the master SAS expander 1 through the first serial port 21, and tests the master SAS expander 1 according to the test command. In one embodiment, the test command is a customized test instruction which is defined according to requirements of users, and is used to test the reliability and functionality of the master SAS expander 2 and each of the slave SAS expanders. The test command may include, but is not limited to, a version testing command (e.g., Rev_Command), a state testing command (e.g., Status_Command), and a register testing command (e.g., Reg_Command). The master SAS expander 2 executes the test command to test whether the master SAS expander 2 works normally or fails to function when the master SAS expander 2 receives the test command from the host computer 1.

In step S33, the master device testing module 102 obtains a test result of the master SAS expander 2 through the first serial port 21, and stores the test result of the master SAS expander 2 into the flash memory 20 of the master SAS expander 2. In the embodiment, the test result of the master SAS expander 2 indicates whether the master SAS expander 2 works normally or fails to function. Referring to FIG. 4, the test result of the master SAS expander 2 is stored in the first data storage block of the flash memory 20.

In step S34, the slave device testing module 103 controls the master SAS expander 2 to transfer the test command to each of the slave SAS expanders 3 in sequence through the second serial port 22, and tests each of the slave SAS expanders 3 according to the test command. In the embodiment, each of the slave SAS expanders 3 executes the test command to test whether the slave SAS expander 3 works normally or fails to function.

In step S35, the slave device testing module 103 obtains a test result of each of the slave SAS expanders 3 through the second serial port 22, and stores the test result of each of the slave SAS expanders 3 into the flash memory 20. In the embodiment, the test result of each of the slave SAS expanders 3 indicates which slave SAS expander 2 works normally or fails to function. In one example with respect to FIG. 4, the test result of the first slave SAS expander 3 is stored in the second data storage block of the flash memory 20, and the test result of the second slave SAS expander 3 is stored in the third data storage block of the flash memory 20.

In step S36, the information displaying module 104 reads the test result of the master SAS expander 2 and the test result of each of the slave SAS expanders 3 from the flash memory 20 through the first serial port 21, and displays all the test results on the display device 13 of the host computer 1. As such, the user can determine which SAS expander works normally or fails to function by analyzing the test results of the SAS expanders.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A host computer being connected to a master serial attached small computer system interface (SAS) expander and a plurality of slave SAS expanders, the host computer comprising:
at least one processor; and
a storage device storing a computer-readable program including instructions that, which when executed by the at least one processor, causes the at least one processor to:
establish a first connection between the host computer and the master SAS expander through a first serial port, and establish a second connection between the master SAS expander and each of the slave SAS expanders in series through a second serial port;
send a test command to the master SAS expander through the first serial port, and test the master SAS expander according to the test command;
obtain a test result of the master SAS expander through the first serial port, and store the test result of the master SAS expander into a flash memory of the master SAS expander;
control the master SAS expander to transfer the test command to each of the slave SAS expanders in sequence through the second serial port, and test each of the slave SAS expanders according to the test command; and
obtain a test result of each of the slave SAS expanders through the second serial port, and store the test result of each of the slave SAS expanders into the flash memory.

2. The host computer according to claim 1, wherein the computer-readable program further causes the at least one processor to:
read the test result of the master SAS expander and the test result of each of the slave SAS expanders from the flash memory through the first serial port; and
display all the test results on a display device of the host computer.

3. The host computer according to claim 1, wherein each of the first serial port and the second serial port is a serial communication physical interface including a data transmitting port and a data receiving port.

4. The host computer according to claim 1, wherein each of the first serial port and the second serial port is configured with a plurality of parameters including a bit rate, data transfer bits, data control bits, and a data checksum.

5. The host computer according to claim 1, wherein the flash memory is divided into a plurality of data storage blocks to store the test result of the master SAS expander and the test result of each of slave SAS expanders.

6. The host computer according to claim 1, wherein the test command is a customized test instruction which is defined according to requirements of users, and comprises a version testing command, a state testing command, and a register testing command for testing reliability and functionality of the master SAS expander and each of the slave SAS expanders.

7. A method for testing serial attached small computer system interface (SAS) expanders using a host computer, the host computer being connected to a master SAS expander and a plurality of slave SAS expanders, the method comprising:
establishing a first connection between the host computer and the master SAS expander through a first serial port;
establishing a second connection between the master SAS expander and each of the slave SAS expanders in series through a second serial port;
sending a test command to the master SAS expander through the first serial port, and testing the master SAS expander according to the test command;
obtaining a test result of the master SAS expander through the first serial port, and storing the test result of the master SAS expander into a flash memory of the master SAS expander;
controlling the master SAS expander to transfer the test command to each of the slave SAS expanders in sequence through the second serial port, and testing each of the slave SAS expanders according to the test command; and
obtaining a test result of each of the slave SAS expanders through the second serial port, and storing the test result of each of the slave SAS expanders into the flash memory.

8. The method according to claim 7, further comprising:
reading the test result of the master SAS expander and the test result of each of the slave SAS expanders from the flash memory through the first serial port; and
displaying all the test results on a display device of the host computer.

9. The method according to claim 7, wherein each of the first serial port and the second serial port is a serial communication physical interface including a data transmitting port and a data receiving port.

10. The method according to claim 7, wherein each of the first serial port and the second serial port is configured with a plurality of parameters including a bit rate, data transfer bits, data control bits, and a data checksum.

11. The method according to claim 7, wherein the flash memory is divided into a plurality of data storage blocks to store the test result of the master SAS expander and the test result of each of slave SAS expanders.

12. The method according to claim 7, wherein the test command is a customized test instruction which is defined according to requirements of users, and comprises a version testing command, a state testing command, and a register testing command for testing reliability and functionality of the master SAS expander and each of the slave SAS expanders.

13. A non-transitory storage medium having stored thereon instructions that, when executed by at least one processor of a host computer, cause the processor to perform a method for testing serial attached small computer system interface (SAS) expanders, the host computer being connected to a master SAS expander and a plurality of slave SAS expanders, the method comprising:
establishing a first connection between the host computer and the master SAS expander through a first serial port;
establishing a second connection between the master SAS expander and each of the slave SAS expanders in series through a second serial port;
sending a test command to the master SAS expander through the first serial port, and testing the master SAS expander according to the test command;
obtaining a test result of the master SAS expander through the first serial port, and storing the test result of the master SAS expander into a flash memory of the master SAS expander;
controlling the master SAS expander to transfer the test command to each of the slave SAS expanders in sequence through the second serial port, and testing each of the slave SAS expanders according to the test command; and
obtaining a test result of each of the slave SAS expanders through the second serial port, and storing the test result of each of the slave SAS expanders into the flash memory.

14. The storage medium according to claim 13, wherein the method further comprises:
reading the test result of the master SAS expander and the test result of each of the slave SAS expanders from the flash memory through the first serial port; and
displaying all the test results on a display device of the host computer.

15. The storage medium according to claim 13, wherein each of the first serial port and the second serial port is a serial communication physical interface including a data transmitting port and a data receiving port.

16. The storage medium according to claim 13, wherein each of the first serial port and the second serial port is configured with a plurality of parameters including a bit rate, data transfer bits, data control bits, and a data checksum.

17. The storage medium according to claim 13, wherein the flash memory is divided into a plurality of data storage blocks to store the test result of the master SAS expander and the test result of each of slave SAS expanders.

18. The storage medium according to claim 13, wherein the test command is a customized test instruction which is defined according to requirements of users, and comprises a version testing command, a state testing command, and a register testing command for testing reliability and functionality of the master SAS expander and each of the slave SAS expanders.
